(19) United States
(12) Patent Application Publication
(10) Pub. No.: US 2022/0037698 A1
(43) Pub. Date: Feb. 3, 2022

(54) NON-AQUEOUS ELECTROLYTE CONTAINING LIFSI SALT FOR FAST CHARGING/DISCHARGING OF LITHIUM-ION BATTERY

(71) Applicant: UT-Battelle, LLC, Oak Ridge, TN (US)

(72) Inventors: Zhijia DU, Oak Ridge, TN (US); Ilias BELHAROUAK, Oak Ridge, TN (US); David L. WOOD III, Oak Ridge, TN (US)

(21) Appl. No.: 17/414,149

(22) PCT Filed: Dec. 16, 2019
(86) PCT No.: PCT/US2019/066435

§ 371 Date: Jun. 15, 2021

Related U.S. Application Data
(60) Provisional application No. 62/780,525, filed on Dec. 17, 2018.

(51) Int. Cl. H01M 10/0568; H01M 10/0525; H01M 10/0569; H01M 4/505; H01M 4/525; H01M 4/587

(52) U.S. Cl. CPC H01M 10/0568; H01M 10/0525; H01M 10/0569; H01M 2300/0025; H01M 4/525; H01M 4/587; H01M 4/505

(57) ABSTRACT

A lithium-ion battery comprising: (a) an anode; (b) a cathode; and (c) an electrolyte composition comprising lithium bis(fluorosulfonyl)imide (LiFSI) dissolved in the following solvent system containing at least the following solvent components: (i) ethylene carbonate and/or propylene carbonate in an amount of 5-70 wt % by weight of the solvent system; and (ii) at least one additional solvent selected from acyclic carbonate, acyclic or cyclic ester, and acyclic or cyclic ether solvents having a molecular weight of no more than 110 g/mol, wherein said at least one additional solvent is in an amount of 30-70 wt % by weight of the solvent system; wherein the wt % amounts for solvent components (i) and (ii), or any additional solvent components (if present) sum to 100 wt %, and wherein LiFSI is present in the solvent system in a concentration of 1.2 M to about 2 M.

### CROSS REFERENCE TO RELATED APPLICATION

The present application claims benefit of U.S. Provisional Application No. 62/780,525, filed on Dec. 17, 2018, all of the contents of which are incorporated herein by reference.

### GOVERNMENT SUPPORT

This invention was made with government support under Prime Contract No. DE-AC05-000R22725 awarded by the U.S. Department of Energy. The government has certain rights in the invention.

### FIELD OF THE INVENTION

The present invention relates generally to electrolyte compositions for lithium-ion batteries, and more particularly, to electrolyte compositions containing LiFSI. The present invention is also directed to lithium-ion batteries containing LiFSI.

### BACKGROUND OF THE INVENTION

Energy density, cost, and safety are, more than ever, the most significant barriers to overcome in order to increase the wide acceptance of Li-ion batteries (LIBs) in electric vehicles (EVs). The U.S. Department of Energy (DOE) has set ultimate goals for battery electric vehicles (BEVs), which include reducing the production cost of the battery pack to $150/kWh, increasing the electrical range of the battery to 300 miles, and decreasing the charging time to 15 minutes or less (e.g., S. Ahmed et al., Journal of Power Sources, vol. 367, 250-262, 2017). Increasing electrode thickness, and hence, increasing active material loading, is an effective way to achieve these energy density and cost targets (e.g., Z. Du et al., J. Appl. Electrochem., 47, 405-415, 2017). The caveat, however, is that thicker electrodes fail during fast charging.

The relationship between battery energy density, power density, and areal capacity in thick electrodes has been actively studied. The results indicate that the rate capability is limited by both the Li-ions mass transport in liquid electrolytes and interfacial overpotential in graphite anodes (e.g., K. G. Gallagher et al., J. Electrochem. Soc., 163, A138-A149, 2016). The findings also indicate that a significant portion of the available energy in thick electrodes cannot be accessed because of the depletion of Li-ions in the electrolyte phase. Indeed, it has been hypothesized that the Li-on concentration in the electrolyte phase is very negligible at the bottom side of the anode before it can saturate at its surface (e.g., S. Atlung, J. Electrochem. Soc., 126, 1311, 1979. Under this scenario, the voltage of the cell drops rapidly due to insufficient lithium ions for promoting the solid-phase intercalation. On the battery design side, it has been suggested that the electrodes need to be thinner than the typical 40-60 μm should fast charging be one of the requirements for EVs (e.g., S. Ahmed et al., supra). Nonetheless, current Li-ion battery chemistries using thin electrodes have a low chance in meeting the requisites of extended electrical drive range and cost despite the power advantage.

One of the major issues in battery extreme fast charging (XFC) is the plating of lithium metal over graphite anodes due to sluggish kinetics. This phenomenon is generally regarded as a major reason for cell performance degradation and failure in a recent battery technology gap analysis (e.g., S. Ahmed et al. and K. G. Gallagher et al., supra). The worst aspect of plating is the dendritic growth of metallic lithium, which not only restricts reversible Li-ions inventory, but also jeopardizes cell safety by shorting (e.g., Z. Li et al., J. Power Sources, 254, 168-182, 2014, and M. Broussely et al., J. Power Sources, 146, 90-96, 2005). This was correlated with the depletion of lithium ions in the electrolyte as modeled by Chazalviel et al(Phys Rev. A, 42, 7355-7367, 1990), and as demonstrated by other research groups (e.g., H. J. Chang et al., J. Am. Chem. Soc., 137, 15209-15216, 2015). Indeed, it was found by an operando transmission x-ray microscopy study that the growth of the dendritic forms of lithium metal was significantly enhanced as a result of the lack of lithium ions in the electrolyte phase near graphite electrode (e.g., J. H. Cheng et al., J. Phys. Chem. C, 121, 7761-7766, 2017). Moreover, a strong correlation has been established between the onset time of dendrite growth and local depletion of electrolytes (e.g., H. J. Chang et al., supra).

One of the conventional solutions for realizing faster charging while retaining substantial battery energy has been enhancing the lithium ion mass transport in electrolytes to result in sufficient lithium ions being available for intercalation in graphite. The mass transport of lithium ions can be evaluated by two macroscopic characteristic values: 1) the lithium-ion ionic conductivity that is related to the total flux of charge carriers, and 2) the lithium-ion transference number that is related to the fraction of the total current that is carried by the lithium ions. An electrolyte with both higher lithium-ion conductivity and transference number is ideal for higher lithium ion transport, and hence, would be a step toward realizing cells with higher charging rates.

Thus far, LiPF₆ has been the most common salt in carbonate mixtures for commercial LIBs, mainly due to its optimum combination of ionic conductivity, ion dissociation, electrochemical window, and electrode interfacial properties. However, LiPF₆ is seldom outstanding with respect to any single parameter, and LiPF₆ has raised safety concerns in large scale plug-in, hybrid, and all electric vehicles (EVs) because of its low chemical and thermal stability (Tarascon, J. M. and M. Armand, Nature, 2001. 414(6861): p. 359-367). Consequently, researchers have focused on other lithium salts to replace LiPF₆. Lithium bis(fluorosulfonyl)imide (LiFSI), in particular, has been studied as an electrolyte salt in lithium-ion batteries. In theory, employing a high concentration (e.g., at least or greater than 1.2 M or 1.5 M) of LiFSI or other electrolyte salt could result in significantly faster charging ability. However, in practice, use of such higher concentrations of LiFSI or other electrolyte salt has resulted in an unacceptable lowering in the conductivity of the electrolyte, which prevents faster charging (E. R. Logan et al., Journal of the Electrochemical Society, 165(2), A21-A30, 2018). Thus, fast charging has not as yet been realized using higher than conventional LiFSI or other electrolyte.

### SUMMARY OF THE INVENTION

In one aspect, the invention is directed to a lithium-ion battery containing an electrolyte composition that includes a higher than conventional concentration (e.g., at least or greater than 1.2 M or 1.5 M) of LiFSI while maintaining a high level of conductivity, contrary to the typical outcome known in the art in which higher concentrations of LiFSI result in a lowering of the conductivity. The present invention achieves this surprising result by employing a specially formulated solvent system in the electrolyte that permits the LiFSI at high concentration to maintain a high conductivity. In turn, the high conductivity at high concentration of LiFSI permits substantially faster charging and discharging than generally possible using conventional electrolytes.

For purposes of the present invention, the electrolyte composition includes LiFSI dissolved in a solvent system containing the following solvent components: (i) ethylene carbonate and/or propylene carbonate in an amount of 5-70 wt % by weight of the solvent system; (ii) at least one additional solvent selected from acyclic carbonate, acyclic or cyclic ester, and acyclic or cyclic ether solvents having a molecular weight of no more than 110 g/mol, wherein the at least one additional solvent is in an amount of 30-70 wt % by weight of the solvent system; and optionally, (iii) a higher molecular weight solvent selected from acyclic carbonate, acyclic or cyclic ester, and acyclic or cyclic ether solvents having a molecular weight above 110 g/mol, wherein the higher molecular weight solvent is in an amount up to 30 wt % by weight of the solvent system; wherein the wt % amounts for solvent components (i), (ii), and (iii) sum to 100 wt %, and wherein LiFSI is present in the solvent system in a concentration of 1.2-2.0 M.

The invention is also directed to the operation of a lithium-ion battery in which the above electrolyte composition is incorporated. As further discussed later in this disclosure, it has herein been found that LiFSI can be used in higher than conventional concentration in a lithium-ion battery to provide both higher Li-ion conductivity and higher Li-ion transference number compared to the conventional LiPF₆ salt. For example, in a 12-minute charge, the electrolyte with LiPF₆ salt reaches the cut-off voltage rapidly while the electrolyte with the LiFSI salt provides a longer constant current charge with more capacity achieved. The LiFSI electrolyte also provides better cycling performance and less lithium plating after repeated fast charging cycles. More specifically, as further discussed later on below, the presently described high-performance electrolyte can provide Li-ion cells with 184.66 Wh/kg energy density achieved in a 12-minute charge and retained at 87.7% level after 500 cycles.

### BRIEF DESCRIPTION OF THE DRAWINGS

FIG. 1. Graph showing conductivity of LiFSI and LiPF₆ in (EC:EMC) (30:70 wt. %) solvent system as function of concentration and temperature.

FIG. 2. Graphs showing voltage (V) and current (I) plotted versus charging time for cells charged at 1C, 2C, 3C and 5C, as shown in panels (a), (b), (c), and (d), respectively, and with time cut-off of 1 hour, 30 minutes, 20 minutes and 12 minutes, respectively. The voltage (V) curves correspond to the y-axis on the left side of each panel while the current (I) curves correspond to the y-axis on the right side of each panel.

FIG. 3. Graph showing discharge voltage curves at C/2 when different charging currents are used with LiPF₆ and LiFSI electrolyte.

FIG. 4. Graph showing long term cycling performance of the cells with LiFSI and LiPF₆ electrolytes with 12 minutes fast charging. The photos show the extent of Li plating on each graphite electrode.

### DETAILED DESCRIPTION OF THE INVENTION

In one aspect, the present disclosure is directed to an electrolyte composition containing lithium bis(fluorosulfonyl)imide (LiFSI) in a concentration of 1.2 M to about 2 M (i.e., 1.2-2 molar) in a specially formulated solvent system that maintains the LiFSI at a high conductivity at such concentrations, wherein the term “about” is generally used herein to indicate a variation from a value of no more than ±10%, ±5%, or ±1%. The term “high conductivity” of the 1.2-2 M LiFSI solution indicates a conductivity of at least 80%, 85%, 90%, or 95% of the conductivity exhibited by a 0.5 M LiFSI solution in the same solvent (e.g., at least or greater than 10, 15, or 20 mS/cm). The term “solvent,” as used herein, refers to a substance or mixture of substances that is liquid at about or slightly above room temperature, e.g., having a melting point up to or less than 20, 30, 35, or 40° C.

In different embodiments, the LiFSI salt is present in the specially formulated solvent system in a concentration of, for example, 1.2 M, 1.3 M, 1.4 M, 1.5 M, 1.6 M, 1.7 M, 1.8 M, 1.9 M, or 2.0 M, or a concentration within a range bounded by any two of the foregoing exemplary values (e.g., 1.5-2 M, 1.5-1.8 M, 1.6-2 M, or 1.7-2 M). In some embodiments, LiFSI is the only lithium salt in the electrolyte composition. In other embodiments, LiFSI is present in combination with one or more other lithium salts. The other lithium salt may be, for example, LiPF₆. In the event that LiFSI is in combination with one or more other lithium salts (e.g., LiPF₆), the one or more other lithium salts may be present in an amount up to or less than, for example, 70 wt %, 60 wt %, 50 wt %, 40 wt %, 30 wt %, 20 wt %, 10 wt %, or 5 wt % of the total weight of lithium salts (and conversely, LiFSI may be present in the electrolyte composition in an amount of at least or greater than 30 wt %, 40 wt %, 50 wt %, 60 wt %, 70 wt %, 80 wt %, 90 wt %, or 95 wt %). Notably, the presence of one or more other lithium salts in any of the exemplary amounts provided above does not negate the requirement for LiFSI to be present in a concentration of 1.2 M to 2 M or any amount therein, as provided above. For purposes of the present invention, the LiFSI salt and any other lithium salt, if present, should be dissolved (i.e., completely soluble) in the specially formulated solvent system.

The specially formulated solvent system contains at least the following two solvent components: (i) ethylene carbonate (EC) and/or propylene carbonate (PC) in an amount of 5-70 wt % by weight of the solvent system; and (ii) at least one additional solvent selected from acyclic carbonate, acyclic or cyclic ester, and acyclic or cyclic ether solvents having a molecular weight of no more than 110 g/mol (or no more than or less than, e.g., 105, 100, 95, or 90 g/mol), wherein the at least one additional solvent is in an amount of 30-70 wt % by weight of the solvent system. Solvent component (i) may or may not also be fluorinated. Some examples of fluorinated versions of solvent component (i) include fluoroethylene carbonate (FEC) and fluoropropylene carbonate (FPC). If the foregoing two solvent components are the only solvent components, then the wt % amounts for solvent components (i) and (ii) sum to 100 wt %. In different embodiments, solvent component (i) is present in the solvent system in an amount of precisely, at least, above, up to, or less than, for example, 5, 10, 15, 20, 25, 30, 35, 40, 45, 50, 55, 60, 65, or 70 wt %, or an amount within a range bounded by any two of the foregoing values. In different embodiments, solvent component (ii) is present in the solvent system in an amount of precisely, at least, above, up to, or less than, for example, 30, 35, 40, 45, 50, 55, 60, 65, or 70 wt %, or an amount within a range bounded by any two of the foregoing values. In some embodiments, solvent component (ii) is present in a higher amount than solvent component (i). In particular embodiments, solvent component (i) is present in an amount of 5-50 wt %, 5-40 wt %, 5-30 wt %, 10-50 wt %, 10-40 wt %, 10-30 wt %, 15-50 wt %, 15-40 wt %, 15-30 wt %, 20-50 wt %, 20-40 wt %, 20-30 wt %, 25-50 wt %, 25-40 wt %, or 25-30 wt %, while solvent component (ii) is present in an amount of 30-70 wt %, 35-70 wt %, 40-70 wt %, 45-70 wt %, 50-70 wt %, 55-70 wt %, or 60-70 wt %.

In some embodiments, a third (optional) solvent component is present, wherein the third solvent component is a higher molecular weight solvent (i.e., having a molecular weight above 110 g/mol, or at least or above 120, 130, 140, or 150 g/mol) selected from acyclic carbonate, acyclic or cyclic ester, and acyclic or cyclic ether solvents, wherein the higher molecular weight solvent is in an amount up to 30 wt % by weight of the solvent system. If the three solvent components are present, the wt % amounts for solvent components (i), (ii), and (iii) sum to 100 wt %. In different embodiments, the third solvent component is present in an amount of up to or less than, for example, 30 wt %, 25 wt %, 20 wt %, 15 wt %, 10 wt %, 5 wt %, 2 wt %, or 1 wt %, or an amount within a range bounded by any two of the foregoing values. Any one or more of the foregoing solvents having a molecular weight above 110 g/mol may alternatively be excluded.

In some embodiments, the specially formulated solvent system may include a sulfone solvent, or a fluorinated derivative of a sulfone solvent, in any of the amounts provided above for the optional third solvent component. Some examples of sulfone solvents include methyl isopropyl sulfone (MiPS), propyl sulfone, butyl sulfone, tetramethylene sulfone (sulfolane), methyl phenyl sulfone, phenyl vinyl sulfone, allyl methyl sulfone, methyl vinyl sulfone, divinyl sulfone (vinyl sulfone), diphenyl sulfone (phenyl sulfone), dibenzyl sulfone (benzyl sulfone), butadiene sulfone, 4-methoxyphenyl methyl sulfone, 4-chlorophenyl methyl sulfone, 2-chlorophenyl methyl sulfone, 3,4-dichlorophenyl methyl sulfone, 4-(methylsulfonyl)toluene, 2-(methylsulfonyl)ethanol, 4-bromophenyl methyl sulfone, 2-bromophenyl methyl sulfone, 4-fluorophenyl methyl sulfone, 2-fluorophenyl methyl sulfone, 4-aminophenyl methyl sulfone, a sultone (e.g., 1,3-propanesultone), and sulfone solvents containing ether groups (e.g., 2-methoxyethyl(methyl)sulfone and 2-methoxyethoxyethyl(ethyl)sulfone). In some embodiments, a sulfone and/or sultone solvent is excluded from the electrolyte composition.

In one embodiment, the solvent component (ii) is or includes an acyclic (i.e., non-cyclic, which may be linear or branched) carbonate solvent having a molecular weight of no more than or less than 110 g/mol. Some examples of such carbonate solvents include dimethyl carbonate (DMC) and ethyl methyl carbonate (EMC). The acyclic carbonate solvent may or may not also be fluorinated, provided the molecular weight remains no more than or less than 110 g/mol, e.g., fluoromethyl methyl carbonate.

In another embodiment, the solvent component (ii) is or includes an acyclic (linear or branched) or cyclic ester solvent having a molecular weight of no more than or less than 110 g/mol. Some examples of acyclic ester solvents for solvent component (ii) include methyl acetate (MA), ethyl acetate (EA), n-propyl acetate, isopropyl acetate, methyl formate (MF), ethyl formate (EF), n-propyl formate (PF), n-butyl formate, t-butyl formate, methyl propionate (MP), ethyl propionate (EP), and methyl butyrate (MB). Some examples of cyclic ester solvents (i.e., lactone solvents) for solvent component (ii) include γ-butyrolactone, α-methyl-γ-butyrolactone, β-butyrolactone, β-propiolactone, γ-valerolactone, and δ-valerolactone. The acyclic or cyclic ester solvent may or may not also be fluorinated, provided the molecular weight remains no more than or less than 110 g/mol, e.g., ethyl fluoroacetate, β-fluoro-γ-butyrolactone and γ-fluoro-γ-butyrolactone.

In another embodiment, the solvent component (ii) is or includes an acyclic or cyclic ether solvent having a molecular weight of no more than or less than 110 g/mol. Some examples of acyclic ether solvents include diethyl ether, diisopropyl ether, ethylpropyl ether, and dimethoxyethane (monoglyme). Some examples of cyclic ether solvents include tetrahydrofuran, furan, 2-methylfuran, 2,5-dimethylfuran, tetrahydropyran, and 1,4-dioxane. The acyclic or cyclic ether solvent may or may not also be fluorinated, provided the molecular weight remains no more than or less than 110 g/mol, e.g., 2-fluorofuran and 3-fluorofuran.

In a first embodiment, the solvent component (iii) is present, and solvent component (iii) is or includes an acyclic (linear or branched) carbonate solvent having a molecular weight above 110 g/mol. Some examples of such carbonate solvents include diethyl carbonate (DEC), methyl propyl carbonate, ethyl propyl carbonate, di-n-propyl carbonate, diisopropyl carbonate, n-butyl methyl carbonate, t-butyl methyl carbonate, di-n-butyl carbonate, and di-t-butyl carbonate. The acyclic carbonate solvent may or may not also be fluorinated, or more particularly, perfluorinated. Some examples of fluorinated acyclic carbonate solvents for solvent component (iii) include 2,2-difluoroethyl ethyl carbonate, bis(2-fluoroethyl)-carbonate, di-2,2,2-trifluoroethyl carbonate (TFEC), and bis(trifluoromethyl)carbonate.

In a second embodiment, the solvent component (iii) is present, and solvent component (iii) is or includes an acyclic (linear or branched) ester solvent having a molecular weight above 110 g/mol. Some examples of such acyclic ester solvents include n-butyl acetate, n-propyl propionate, n-butyl propionate, ethyl butyrate, and n-propyl butyrate. The acyclic ester solvent may or may not also be fluorinated, or more particularly, perfluorinated. Some examples of fluorinated acyclic ester solvents for solvent component (iii) include 2,2,2-trifluoromethyl acetate, 2,2,2-trifluoroethyl acetate, 2,2,2-trifluoroethyl butyrate, trifluoromethyl formate, and trifluoroethyl formate.

In a third embodiment, the solvent component (iii) is present, and solvent component (iii) is or includes a cyclic ester solvent having a molecular weight above 110 g/mol. Some examples of such cyclic ester solvents include α-bromo-γ-butyrolactone, γ-phenyl-γ-butyrolactone, ε-caprolactone, γ-caprolactone, δ-caprolactone, γ-octanolactone, γ-nanolactone, γ-decanolactone, and δ-decanolactone. The cyclic ester solvent may or may not also be fluorinated, or more particularly, perfluorinated. An example of a fluorinated cyclic ester solvent for solvent component (iii) is α-fluoro-ε-caprolactone.

In a fourth embodiment, the solvent component (iii) is present, and solvent component (iii) is or includes an acyclic ether solvent having a molecular weight above 110 g/mol. Some examples of such acyclic ether solvents include diglyme (i.e., bis(2-methoxyethyl)ether), triglyme (i.e., triethylene glycol dimethyl ether), and tetraglyme (i.e., tetraethylene glycol dimethyl ether). The acyclic ether solvent may or may not also be fluorinated, or more particularly, perfluorinated. Some examples of fluorinated acyclic ether solvents for solvent component (iii) include 1,1,2,2-tetrafluoroethyl-2,2,3,3-tetrafluoropropyl ether, bis(2,2,2-trifluoroethyl)ether, perfluoro-1,2-dimethoxyethane, and perfluorodiglyme.

In a fifth embodiment, the solvent component (iii) is present, and solvent component (iii) is or includes a cyclic ether solvent having a molecular weight above 110 g/mol. An example of such a cyclic ether solvent is 12-crown-4. The cyclic ether solvent may or may not also be fluorinated, or more particularly, perfluorinated. Some examples of fluorinated cyclic ether solvents for solvent component (iii) include 3,4-bis(trifluoromethyl)furan and 2,2,3,3,4,4,5-heptafluoro-5-(1,1,2,2,3,3,4,4,4-nonafluorobutyl)tetrahydrofuran (also known as Fluorinert™ FC-75 or perfluoro(butyltetrahyrofuran)).

A solvent additive may or may not also be included in the electrolyte. If present, the solvent additive should typically facilitate formation of a solid electrolyte interphase (SEI) on the anode. The solvent additive can be, for example, a solvent that possesses one or more unsaturated groups containing a carbon-carbon double bond and/or one or more halogen atoms. Some particular examples of solvent additives include vinylene carbonate (VC), vinyl ethylene carbonate, allyl ethyl carbonate, vinyl acetate, divinyl adipate, acrylic acid nitrile, 2-vinyl pyridine, maleic anhydride, methyl cinnamate, ethylene carbonate, halogenated ethylene carbonate, bromobutyrolactone, methyl chloroformate, and sulfite additives, such as ethylene sulfite (ES), propylene sulfite (PS), and vinyl ethylene sulfite (VES). In other embodiments, the additive is selected from 1,3-propanesultone, ethylene sulfite, propylene sulfite, fluoroethylene sulfite (FEC), α-bromo-γ-butyrolactone, methyl chloroformate, t-butylene carbonate, 12-crown-4 ether, carbon dioxide (CO₂), sulfur dioxide (SO₂), sulfur trioxide (SO₃), acid anhydrides, reaction products of carbon disulfide and lithium, and polysulfide. The additive is generally included in an amount that effectively impacts SEI formation without reducing the electrochemical window by an appreciable extent, i.e., below about 5.0V. The additive may be included in an amount of, for example, 0.1, 0.5, 1, 2, 3, 4, 5, or 10 wt % by weight of the electrolyte, or an amount within a range bounded by any two of the foregoing exemplary values. In some embodiments, any one or more of the above disclosed additives is excluded.

The electrolyte composition may or may not include one or more further (i.e., secondary or tertiary) lithium salts, in addition to LiFSI. The additional lithium salt may be present in an amount of, for example, 1, 2, 5, 10, 15, 20, 25, 30, 35, 40, 45, 50, 55, 60, 65, or 70 wt % by weight of the sum of LiFSI and the one or more additional lithium salts, or the one or more additional lithium salts may be present in an amount within a range bounded by any two of the foregoing values. If one or more additional lithium salt is present, LiFSI may be present in an amount of, for example, 30, 35, 40, 45, 50, 55, 60, 65, 70, 75, 80, 85, 90, 95, 98, or 99 wt % by weight of the sum of LiFSI and the one or more additional lithium salts, or LiFSI may be present in an amount within a range bounded by any two of the foregoing values. For example, the lithium salt be composed of 90% LiFSI and 10% LiPF₆, or 30-99% LiFSI and 1-70% LiPF₆, or 30-100% LiFSI and 0-70% LiPF₆.

The additional lithium salt can be any of the lithium salts (lithium ion electrolytes) known in the art for use in lithium-ion batteries. The additional lithium salt can be a combination of lithium ions and inorganic counteranions. Some examples of inorganic counteranions include the halides (e.g., chloride, bromide, or iodide), hexafluorophosphate (PF₆⁻), hexachlorophosphate (PCl₆⁻), perchlorate, chlorate, chlorite, perbromate, bromate, bromite, iodate, aluminum fluorides (e.g., AlF₄⁻)), aluminum chlorides (e.g., Al₂Cl₇⁻ and AlCl₄⁻), aluminum bromides (e.g., AlBr₄⁻), nitrate, nitrite, sulfate, sulfite, phosphate, phosphite, arsenate, hexafluoroarsenate (AsF₆⁻), antimonate, hexafluoroantimonate (SbF₆⁻), selenate, tellurate, tungstate, molybdate, chromate, silicate, the borates (e.g., borate, diborate, triborate, tetraborate), tetrafluoroborate, anionic borane clusters (e.g., B₁₀H₁₀²⁻ and B₁₂H₁₂²⁻), perrhenate, permanganate, ruthenate, perruthenate, and the polyoxometallates, or any of the counteranions (X⁻) provided above for the ionic liquid. The additional lithium salt can alternatively be a combination of lithium ions and organic counteranions. Some examples of organic counteranions include the fluorosulfonimides (e.g., (CF₃SO₂)₂N⁻), fluorosulfonates (e.g., CF₃SO₃⁻, CF₃CF₂SO₃⁻, CF₃(CF₂)₂SO₃⁻, CHF₂CF₂SO₃⁻, and the like), carboxylates (e.g., formate, acetate, propionate, butyrate, valerate, lactate, pyruvate, oxalate, malonate, glutarate, adipate, decanoate, and the like), sulfonates (e.g., CH₃SO₃⁻, CH₃CH₂SO₃⁻, CH₃(CH₂)₂SO₃⁻, benzenesulfonate, toluenesulfonate, dodecylbenzenesulfonate, and the like), organoborates (e.g., BR₁R₂R₃R₄⁻, wherein R₁, R₂, R₃, R₄ are typically hydrocarbon groups containing 1 to 6 carbon atoms), dicyanamide (i.e., N(CN)₂⁻), and the phosphinates (e.g., bis-(2,4,4-trimethylpentyl)-phosphinate). In some embodiments, any one or more classes or specific types of additional lithium salts, as provided above, are excluded from the electrolyte.

In another aspect, the invention is directed to a lithium-ion battery containing any of the electrolyte compositions described above. The lithium-ion battery may contain any of the components typically found in a lithium-ion battery, including positive (cathode) and negative (anode) electrodes, current collecting plates, a battery shell, such as described in, for example, U.S. Pat. Nos. 8,252,438, 7,205,073, and 7,425,388, the contents of which are incorporated herein by reference in their entirety.

The positive (cathode) electrode can be, for example, a lithium metal oxide, wherein the metal is typically a transition metal, such as Co, Fe, Ni, or Mn, or combination thereof. In specific embodiments, the cathode has a composition containing lithium, nickel, and oxide. In further embodiments, the cathode has a composition containing lithium, nickel, manganese, and oxide. Some examples of cathode materials include LiCoO₂, LiMn₂O₄, LiNiCoO₂, LiMnO₂, LiFePO₄, and LiNiₓMn₂₋ₓO₄ compositions, such as LiNi_{0.5}Mn_{1.5}O₄, the latter of which are particularly suitable as 5.0V cathode materials, wherein x is a number greater than 0 and less than 2. In some embodiments, one or more additional elements may substitute a portion of the Ni or Mn. In further specific embodiments, the cathode has a composition containing lithium, nickel, manganese, cobalt, and oxide, such as LiN_{w-y-z}Mn_{y}Co_{z}O₂ composition (wherein w+y+z=1), or more specifically, LiNi_{0.8}Mn_{0.1}Co_{0.1}O₂. The cathode may alternatively have a layered-spinel integrated Li[Ni_{1/3}Mn_{2/3}]O₂ composition, as described in, for example, Nayak et al., Chem. Mater., 2015, 27 (7), pp. 2600-2611. To improve conductivity at the cathode, conductive carbon material (e.g., carbon black, carbon fiber, or graphite) is typically admixed with the positive electrode material.

The negative (anode) electrode is typically a carbon-based composition in which lithium ions can intercalate or embed, such as elemental carbon, such as graphite (e.g., natural or artificial graphite), petroleum coke, carbon fiber (e.g., mesocarbon fibers), or carbon (e.g., mesocarbon) microbeads. The anode is typically at least 70 80, 90, or 95 wt % elemental carbon. The positive and negative electrode compositions are typically admixed with an adhesive (e.g., PVDF, PTFE, and co-polymers thereof) in order to be properly molded as electrodes. Typically, positive and negative current collecting substrates (e.g., Cu or Al foil) are also included. The assembly and manufacture of lithium-ion batteries are well known in the art.

In yet another aspect, the invention is directed to a method of operating a lithium-ion battery that contains any of the electrolyte compositions described above. The operation of lithium-ion batteries is well known in the art. By incorporating the above-described electrolyte composition in a lithium-ion battery, the lithium-ion battery can advantageously perform at substantially greater capacity (e.g., at least 10, 15, 20, or 25% greater capacity) than lithium-ion batteries containing conventional electrolyte compositions. More particularly, the high-performance electrolyte can provide Li-ion batteries with at least 170, 175, 180, or 185 Wh/kg energy density achieved in a 12-minute, 15-minute, or 20-minute charge and retained at a level of at least or above 80% or 85% over a number of cycles up to or at least 200, 300, 400, 500, 600, 700, 800, 900, or 1000 cycles. In some embodiments, the lithium-ion battery is operated at a specified (maintained) elevated temperature, e.g., precisely or at least 30, 35, 40, 45, or 50° C., to improve the capacity and cycling performance.

Examples have been set forth below for the purpose of illustration and to describe certain specific embodiments of the invention. However, the scope of this invention is not to be in any way limited by the examples set forth herein.

### Examples

Synthesis of Lithium-Ion Battery Cells

LiNi_{0.8}Mn_{0.1}Co_{0.1}O₂ (NMC811) and graphite electrodes were fabricated as follows. The positive electrode composition was 90 wt. % NMC811, 5 wt. % carbon black, and 5 wt. % polyvinylidene fluoride (PVDF). The areal capacity of the electrode was 2.35 mAh/cm² after calendaring to 30% porosity. The negative electrode composition was 92 wt. % graphite, 2 wt. % carbon black, and 6 wt. % polyvinylidene fluoride (PVDF). The areal capacity was 2.6 mAh/cm² after calendaring to 30% porosity.

The electrolytes were made of 1.5 M lithium salts dissolved in a combination of ethylene carbonate (EC) and ethyl methyl carbonate (EMC) (30:70 wt. %). The lithium salts were LiPF₆ (purity ≥99.99%), LiFSI (purity ≥99.95%), and lithium bis(trifluoromethanesulfonyl)imide (LiTFSI) (purity ≥99.9%).

The pouch cells were assembled with one layer of anode, one layer of cathode, and one layer of separator (Celgard® 2325). The cells were vacuum filled with the electrolytes. Cell assembly was performed inside a dry room with a dew point of less than −50° C. and relative humidity (RH) of 0.1% at BMF. The cells were cycled between 2.5 and 4.2 V using the battery cycler, Maccor Series 4000, coupled with an environmental chamber set at 30° C. Three cell duplicates were fabricated and tested to ensure reproducibility.

Conductivity Measurements

Conductivity measurements of the electrolyte were performed using a conductivity cell. The conductivity cell was calibrated using standard KCl solutions. The conductivities were measured using electrochemical impedance spectroscopy from 10 Hz to 1 MHz with a 6 mV perturbation voltage using a potentiostat. As for transference number measurement, an electrochemical method similar to previous reports was used (J. Zhao et al., J. Electrochem. Soc. 155 (2008) A292. doi:10.1149/1.2837832; S. Zugmann et al., Electrochim. Acta. 56 (2011) 3926-3933.). In essence, a non-blocking cell was assembled using a revised conflat cell (K. Periyapperuma et al., J. Electrochem. Soc. 161 (2014), doi:10.1149/2.0721414jes) with two stainless steel (SS) spacers as current collectors in close contact with two lithium metal disks sandwiching a high-density polyethylene cylinder. The cylinder was filled with the electrolytes, and the distance between the two lithium disks was 8 mm. A voltage bias of 5 mV was applied during the potentiostatic polarization experiments, and the impedances were measured in the frequency range of 1-100 kHz with a 5 mV perturbation voltage using a potentiostat.

Results and Discussion

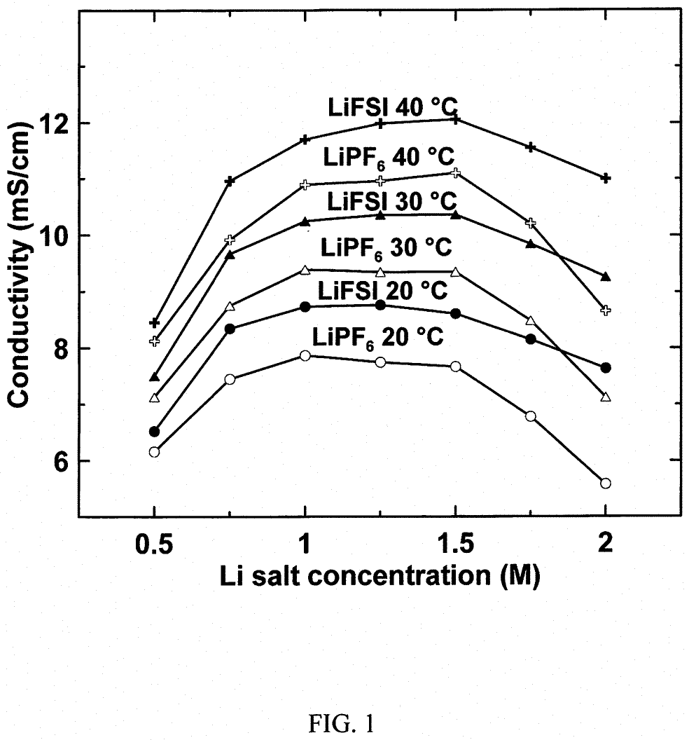

FIG. 1 shows the conductivity of electrolytes, measured at 20, 30 and 40° C., as a function of LiPF₆ or LiFSI concentrations in the solvent system (EC: EMC) (30:70 wt. %). With the increase of concentrations of the lithium salts from 0.5 to 1 M, the conductivity increased due to the increased number of dissociated ions in the electrolyte solutions. With further increase of the salt concentrations, the cationic and anionic species form pairs, and hence, do not contribute to conductivity, in agreement with other reports (M. S. Ding et al., J. Electrochem. Soc. 148 (2001) A1196. doi:10.1149/1.1403730). In the present case, the conductivity reached topmost values in the range of 1-1.5 M, and then decreased thereafter. With the increase of temperature, the maximal conductivity values shifted from 1 M at 20° C. to 1.5 M at 40° C., owing to higher thermal agitation that increases the dissociation of ion pairs. When comparing the two lithium salts, LiFSI has a higher conductivity compared to LiPF₆, whether as a function of concentration or temperature, and this finding is in agreement with a previous report ascribing the higher conductivity to a higher degree of dissociation of LiFSI (H. B. Han et al., J. Power Sources (2011) doi:10.1016/j.jpowsour.2010.12.040). Another interesting finding is that the conductivity drop for LiFSI from 1.5 to 2 M concentrations was less severe than for LiPF₆, which is expected to ease the electrolyte depletion issue when fast charging and discharging is applied to Li-ion cells (Z. Du et al., J. Appl. Electrochem. 47 (2017) 405-415. doi:10.1007/s10800-017-1047-4.).

The lithium-ion transference number (t₊), which is another important electrolyte feature, is expressed by the following equation (J. Evans et al., Polymer (Guild®. 28 (1987) 2324-2328. doi:10.1016/0032-3861(87)90394-6):

$${t}_{+} = \frac{{I}_{ss} ( Δ V - {I}_{0} {R}_{0} )}{{I}_{0} ( Δ V - {I}_{ss} {R}_{ss} )}$$

where Iₛₛ is the steady-state current, I₀ is the initial current, ΔV is the applied potential, and R₀ and Rₛₛ are the electrode resistances before and after polarization, respectively. The electrolyte with the LiPF₆ salt has a t₊ of 0.382, which is within the range of 0.24 to 0.39 as reported by others (e.g., J. Zhao and S. Zugmann references cited above), and the t₊ of the LiFSI based electrolyte measured in this study is 0.495. A possible explanation is that both the higher dissociation of the LiFSI salt in the electrolyte and the larger size of the FSI⁻ anion contribute to the transference number increase. The higher dissociation indicates that lithium ions can move more freely due to less attractive forces by the anions. The larger size of FSI⁻ (95 Å³, H. B. Ban et al., supra) compared to PF₆⁻ (69 Å³) suggests slower movement of FSI⁻, and, as a result, lithium ions are able to move faster in the presence of the FSI⁻ ions, and thus, have a higher transference number compared to PF₆⁻.

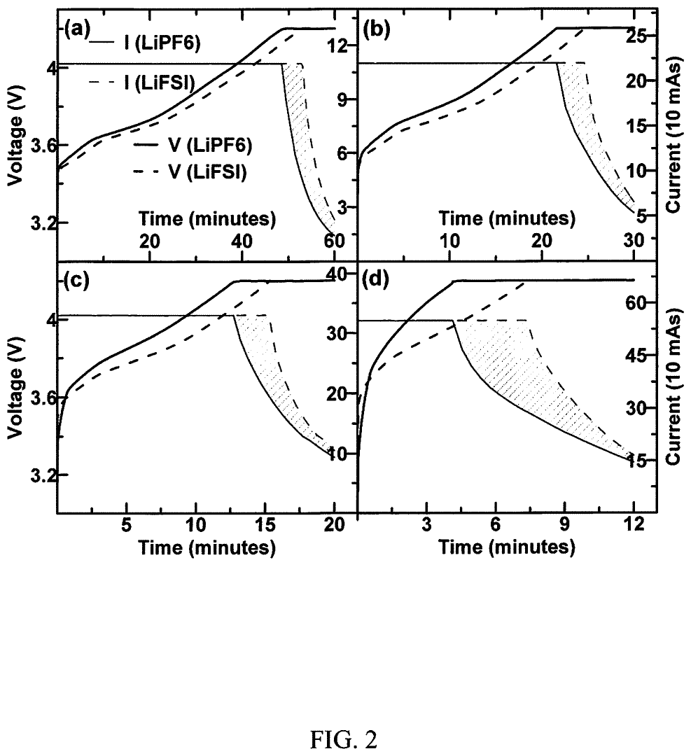

FIG. 2 presents graphs showing voltage (V) and current (I) versus charging time for cells charged at 1C, 2C, 3C and 5C, as shown in panels (a), (b), (c), and (d), respectively, and with time cut-off of 1 hour, 30 minutes, 20 minutes and 12 minutes, respectively. The voltage (V) curves correspond to the y-axis on the left side of each panel while the current (I) curves correspond to the y-axis on the right side of each panel. FIG. 2 shows the fast charging capability of the cell containing LiNi_{0.8}Mn_{0.1} Co_{0.1}O₂ (NMC811) as the cathode and graphite as the anode and in the presence of the LiFSI and LiPF₆ based electrolytes. Under the 1C rate (panel a), the cell voltages gradually increased during the constant current (CC) charging and reached the cut-off voltage (4.2 V) around 49.5 minutes (LiPF₆) and 53.1 minutes (LiFSI). The cells were further charged under the constant voltage (CV) mode with a decreasing trickle current until the overall charging reached 60 minutes. With increasing the charge current to 2C (panel b) and 3C (panel c), the cells with the LiPF₆ electrolyte achieved the cut-off voltage earlier than the ones with the LiFSI electrolyte. This gap widened even further under a 5C charge, as shown in panel (d). In this case, the cell with the LiPF₆ electrolyte had only 4.2 minutes under the CC charge while the one with the LiFSI electrolyte had 7.4 minutes under the CC charge. This large gap (shaded areas in FIG. 2) between the plots of the current (I) vs. time indicates that more capacity can be stored when the cell has a longer CC charging time under the intended C-rate.

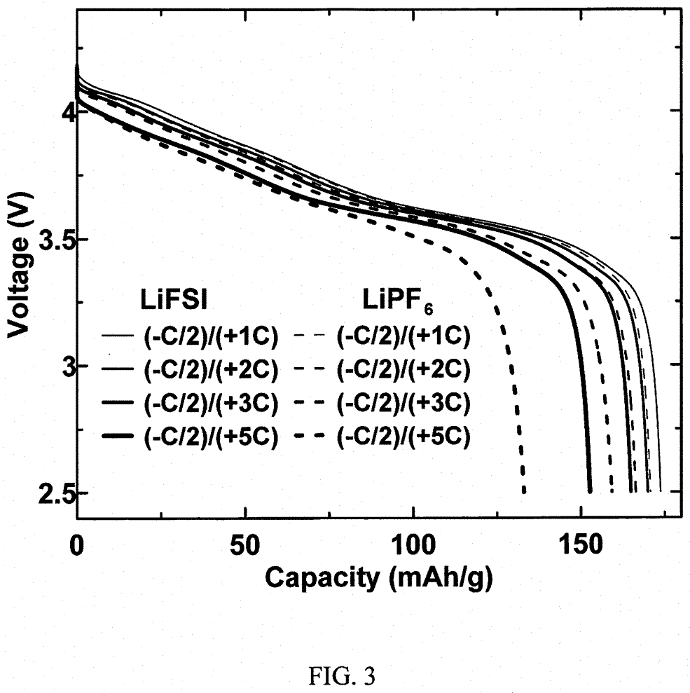

FIG. 3 is a graph showing discharge voltage curves at C/2 when different charging currents are used with LiPF₆ and LiFSI electrolyte. FIG. 3 shows the corresponding discharge voltage curves at the C/2 rate for the cells charged under 1C, 2C, 3C and 5C rates, as shown in FIG. 2. When the cells were charged in one hour, they delivered 173.8 and 170.8 mAh/g capacity in the presence of the LiFSI and LiPF₆ electrolyte, respectively. The capacity difference grew further when the charge rate was increased to 5C and charging time shortened to 12 minutes. The cell with the LiFSI electrolyte had a capacity of 153.2 mAh/g, which is a 13% improvement over the LiPF₆ electrolyte (i.e. 135.4 mAh/g).

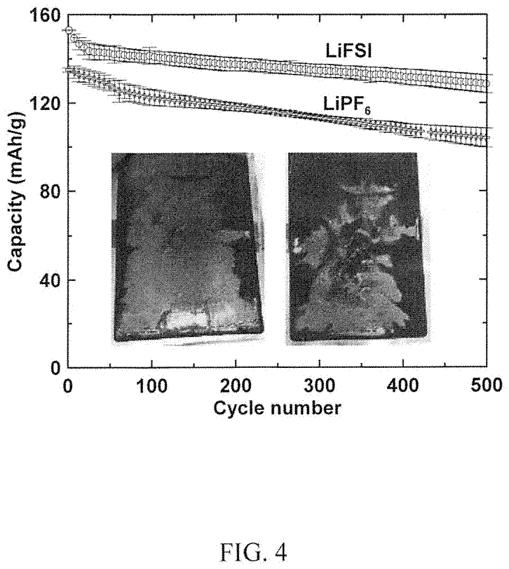

FIG. 4 is a graph showing long term cycling performance of the cells with LiFSI and LiPF₆ electrolytes with 12 minutes fast charging. More particularly, FIG. 4 shows the cycling performance of under 12-minute fast charging through 500 cycles, and the photos show the extent of Li plating on each graphite electrode. The cell with the LiFSI electrolyte exhibited minimal capacity fading over the 500 cycles with 134.3 mAh/g capacity retained (87.7% retention compared to 1st cycle of 12-minute charge). The cell with LiPF₆ electrolyte showed rapid capacity fading during the first 100 cycles and then decreased steadily with further cycling. This cell only had 110.6 mAh/g capacity retained (81.7% retention) after 500 cycles. The cells were opened inside an Ar-filled glove box after discharging to 2.0 V for observation. Both cells showed lithium platting after repeated fast charging cycles. However, the lithium plating area on the graphite electrode was much smaller for the LiFSI electrolyte compared to the LiPF₆ electrolyte, which is ascribed to the better Li-ion transport properties of the LiFSI based electrolyte compared to the LiPF₆ one. The LiTFSI salt was also evaluated for fast charging purposes. In the evaluation, the cell capacity dropped rapidly to zero after only 60 cycles. Severe lithium plating and aluminum corrosion were observed on anode and cathode electrodes, respectively, which indicates that the LiTFSI salt is not suitable for fast charging.

To evaluate the cells for automotive applications, the electrode and cell design BatPac model was used, and the summary is shown in Table I below. The cathode thickness was set at 55 μm and the pouch cell had a capacity of 60 Ah. The cell mass/volume ratio was 1.038 kg/443 mL for the LiFSI electrolyte cell, while the mass/volume ratio was 1.050 kg/447 mL for the LiPF₆ electrolyte cell. Based on the above experimental results, for a 1-hour charge, the cells with the two different electrolytes can deliver similar energy density, which translates to the same driving range. The cell energy dropped when shorter charging times were used. However, the cells using the LiFSI electrolyte performed much better than cells with the LiPF₆ electrolyte. LiFSI was able to deliver 184.66 Wh/kg energy density when charged in 12 minutes, and also maintained 161.78 Wh/kg after 500 fast charge cycles. LiPF₆ demonstrated a 160.37 Wh/kg energy density with 132.76 Wh/kg left after 500 cycles, which further indicates that LiFSI is a better lithium salt for fast charging Li-ion cells compared to LiPF₆.

TABLE I
BatPac cell parameters in 60 Ah pouch cells when different
electrolytes are used.

| | | | | | Gravi- | Volumet- |
|---|---|---|---|---|---|---|
| | | | | | metric | ric |
| Salt in | Charging | | | Cell | energy | energy |
| elec- | time | Capacity | Voltage | energy | density | density |
| trolyte | (minutes) | (mAh/g) | (V) | (Wh) | (Wh/kg) | (Wh/L) |
| LiFSI | 60 | 173.8 | 3.69 | 220.58 | 212.51 | 497.93 |
| | 30 | 170.0 | 3.68 | 215.15 | 207.27 | 485.66 |
| | 20 | 165.0 | 3.67 | 208.23 | 200.61 | 470.04 |
| | 12^{a} | 153.2 | 3.64 | 191.67 | 184.66 | 432.67 |
| | 12^{b} | 134.3 | 3.64 | 167.93 | 161.78 | 379.08 |
| LiPF⁶ | 60 | 170.8 | 3.69 | 220.58 | 210.08 | 493.48 |
| | 30 | 166.5 | 3.68 | 210.30 | 200.29 | 470.47 |
| | 20 | 159.4 | 3.66 | 200.18 | 190.65 | 447.84 |
| | 12^{a} | 135.4 | 3.62 | 168.39 | 160.37 | 376.71 |
| | 12^{b} | 110.6 | 3.67 | 139.40 | 132.76 | 311.85 |

^{a}The first cycle using 12 minutes charge;
^{b}The 500^{th} cycle using 12 minutes charge

In this work, the fast charging performance of high-energy density (NMC811/graphite) Li-ion cells was studied when different lithium salts were used in the electrolyte. LiFSI showed both higher ionic conductivity and Li-ion transference number compared to LiPF₆. During a 12-minute fast charging step, cells with LiPF₆ electrolyte reached the cut-off voltage in 4.2 minutes, which is much earlier compared to 7.4 minutes for LiFSI. LiFSI electrolyte showed 13% capacity improvement in the first cycle of the 12-minute charge. The capacity retention was also significantly higher at 87.7% after 500 cycles with less lithium plating observed. In a BatPac calculation simulating 60 Ah cells, LiFSI electrolyte was able to deliver 184.66 Wh/kg energy density with 161.78 Wh/kg retained after 500 cycles, which is much greater than the LiPF₆ based electrolyte. From a practical perspective, the excellent fast charging performance achieved here represents significant progress towards more widespread use of battery electric vehicles (BEVs).

While there have been shown and described what are at present considered the preferred embodiments of the invention, those skilled in the art may make various changes and modifications which remain within the scope of the invention defined by the appended claims.

1. A lithium-ion battery comprising:
(a) an anode;
(b) a cathode; and
(c) an electrolyte composition comprising lithium bis(fluorosulfonyl)imide (LiFSI) dissolved in a solvent system comprising the following solvent components: (i) ethylene carbonate and/or propylene carbonate in an amount of 5-70 wt % by weight of the solvent system; (ii) at least one additional solvent selected from acyclic carbonate, acyclic or cyclic ester, and acyclic or cyclic ether solvents having a molecular weight of no more than 110 g/mol, wherein said at least one additional solvent is in an amount of 30-70 wt % by weight of the solvent system; and optionally, (iii) a higher molecular weight solvent selected from acyclic carbonate, acyclic or cyclic ester, and acyclic or cyclic ether solvents having a molecular weight above 110 g/mol, wherein said higher molecular weight solvent is in an amount up to 30 wt % by weight of the solvent system; wherein the wt % amounts for solvent components (i), (ii), and (iii) sum to 100 wt %, and wherein said LiFSI is present in the solvent system in a concentration of 1.2 M to about 2 M.

2. The lithium-ion battery of claim 1, wherein solvent component (i) is in an amount of 5-40 wt % and solvent component (ii) is present in an amount of 30-70 wt % and in a greater amount than solvent component (i).

3. The lithium-ion battery of claim 1, wherein solvent component (i) is in an amount of 10-30 wt % and solvent component (ii) is present in an amount of 30-70 wt % and in a greater amount than solvent component (i).

4. The lithium-ion battery according to claim 1, wherein solvent component (ii) is selected from the group consisting of dimethyl carbonate, ethyl methyl carbonate, methyl acetate, ethyl acetate, methyl formate, ethyl formate, propyl formate, methyl propionate, ethyl propionate, methyl butyrate, diethyl ether, tetrahydrofuran, and dimethoxyethane (monoglyme).

5. The lithium-ion battery according to claim 1, wherein solvent component (iii) is present.

6. The lithium-ion battery of claim 5, wherein solvent component (iii) is in an amount of up to 20 wt %.

7. The lithium-ion battery of claim 5, wherein solvent component (iii) is selected from the group consisting of diethyl carbonate, methyl propyl carbonate, ethyl butyrate, propyl butyrate, diglyme, triglyme, and tetraglyme.

8. The lithium-ion battery according to claim 1, wherein solvent component (ii) is selected from at least one of dimethyl carbonate, methyl acetate, and ethyl acetate.

9. The lithium-ion battery according to claim 1, wherein said concentration of LiFSI is 1.5-2.0 M.

10. The lithium-ion battery according to claim 1, wherein said concentration of LiFSI is 1.5-1.8 M.

11. The lithium-ion battery according to claim 1, wherein said concentration of LiFSI is 1.6-2.0 M.

12. The lithium-ion battery according to claim 1, wherein said concentration of LiFSI is 1.7-2.0 M.

13. The lithium-ion battery according to claim 1, wherein said anode is at least 90 wt % elemental carbon.

14. The lithium-ion battery of claim 13, wherein said elemental carbon is graphite.

15. The lithium-ion battery according to claim 1, wherein said cathode has a composition comprising lithium, nickel, and oxide.

16. The lithium-ion battery according to claim 1, wherein said cathode has a composition comprising lithium, nickel, manganese, and oxide.

17. The lithium-ion battery according to claim 1, wherein said cathode has a LiNiₓMn₂₋ₓO₄ composition, where one or more additional elements may substitute a portion of the Ni or Mn, wherein x is a number greater than 0 and less than 2.

18. The lithium-ion battery according to claim 1, wherein said cathode has a composition comprising lithium, nickel, manganese, cobalt, and oxide.

19. The lithium-ion battery of claim 18, wherein said cathode has a LiNi_{w-y-z}Mn_{y}Co_{z}O₂ composition, wherein w+y+z=1.

20. The lithium-ion battery of claim 19, wherein said cathode has a LiNi_{0.8}Mn_{0.1}Co_{0.1}O₂ composition.
